(19) United States
(12) Patent Application Publication
(10) Pub. No.: US 2005/0114686 A1
(43) Pub. Date: May 26, 2005

(54) System and method for multiple users to securely access encrypted data on computer system

(75) Inventors: Charles Douglas Ball, Raleigh, NC (US); Ryan Charles Catherman, Raleigh, NC (US); Philip Lee Childs, Raleigh, NC (US); James Patrick Hoff, Raleigh, NC (US); Andy Lloyd Trotter, Lincolnton, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/718,786

(22) Filed: Nov. 21, 2003

(51) Int. Cl. H04L 9/32

(52) U.S. Cl. 713/193

(57) ABSTRACT

A method and system for encrypting non-volatile storage regions, such as volumes, accessible by multiple users. A plurality of non-volatile storage regions is encrypted each with a different encryption key. A subset of the encryption keys is made available to each user thereby granting the user access to a corresponding subset of non-volatile storage regions. To protect a user's encryption keys, a private-public encryption key pair is generated, the private key being made available only to that user. The subset of the user's encryption keys is encrypted using the user's public encryption key. The users' private keys can be stored in a secure encryption module and can be protected with a password. Upon authenticating a user, the corresponding encryption keys may be provided to the user after decrypting the encryption keys using the user's private key. The contents of the non-volatile storage regions are then decrypted using the encryption keys.

### BACKGROUND OF THE INVENTION

1. Technical Field

The present invention relates in general to a system and method for multiple users to securely access encrypted data on a computer system. In particular, the present invention relates to a system and a method for encrypting non-volatile storage regions each with a different encryption key and making available different subsets of the encryption keys to different users.

2. Description of the Related Art

Businesses store increasingly large amount of sensitive, propriety data on computer systems that are accessed and used by multiple users. As the number of users accessing and using a computer system increases, it becomes increasingly difficult to protect the data from unauthorized access. If an unauthorized person obtains one of the users' passwords, for example, the whole system is compromised. Portable computer systems such as laptops are especially vulnerable to unauthorized access since often such systems are used away from a company's site.

Encryption is one of the methods being used to protect data stored on computer systems. Several software and hardware solutions exist than can encrypt part or all of the data on a hard disk, for example. In systems where software full-disk encryption is being used, the encryption software may be loaded either by the master boot record or the BIOS and then control the flow of data in and out of the disk, decrypting data flowing out of the disk and encrypting data flowing into the disk. The data is typically encrypted using a symmetric key, which may itself be encrypted for additional security. For example, on a computer system having a trusted platform module (TPM), the symmetric key may be encrypted by the TPM using each user's public key from a private-public key pair. The private key is securely stored within the TPM.

After a user is successfully authenticated by the TPM, the user is given access to the symmetric key, which may then be used to decrypt the contents of the hard disk. In a multiple user environment, each authenticated user (and any unauthorized user who obtains a user's password) would have access to the same symmetric key and thus could potentially decrypt and gain access to all the data on the hard disk. The access would not be limited to that user's data and the common data.

What is needed, therefore, is a system and method that could restrict users from decrypting and accessing regions of the disk to which the users do not require access. For example, users do not need to have access to other users' user-specific data. The system and method should provide the users with the capability to only unlock portions of the disk to which the users need access. Any unauthorized access to the system by obtaining a user's password would then limit the unauthorized access to that user's accessible portions of the disk. The unauthorized person would not be able to gain access to the whole disk.

### SUMMARY

It has been discovered that the aforementioned challenges can be addressed by a system and a method for encrypting different regions of non-volatile storage (such as a hard disk) using different encryption keys for each region. Each user may then be provided only with the encryption keys corresponding to the non-volatile storage regions to which a user requires (and should be granted) access.

A plurality of non-volatile storage regions is encrypted, each non-volatile storage region being encrypted with a different non-volatile storage region encryption key. The non-volatile storage regions may be, for example, different volumes such as partitions of a hard disk or separate hard disks or different directories/folders. One of the non-volatile storage regions may store an operating system and data common to the registered users of the computer system, and the other non-volatile storage regions may store user-specific data of the registered users.

A first subset of the encryption keys is made available to a first user thereby granting to the first user access to a corresponding first subset of non-volatile storage regions. A second subset of the encryption keys is made available to a second user thereby granting the second user access to a corresponding second subset of non-volatile storage regions. The first and second subsets of the encryption keys may consist of one, a plurality, or all of the encryption keys.

To protect each user's encryption keys, a first private-public encryption key pair and a second private-public encryption key pair are generated. The first private key is made available only to the first user and the second private key is made available only to the second user. The first subset of the encryption keys is then encrypted using the first public encryption key, and the second subset of the encryption keys is encrypted using the second public encryption key.

To protect access to the private keys, the first private key and the second private key are stored in a secure encryption module. Access to the first private key is protected with a first password known only to the first user, and access to the second private key is protected with a second password known only to the second user.

When a user attempts to access one or more of the non-volatile storage regions, the secure encryption module requests the user to enter a password. The user is authenticated if the user's password matches one of the passwords stored within the secure encryption module.

In response to authenticating the user, the secure encryption module decrypts a corresponding subset of encryption keys using the authenticated user's private key. Subsequently, using the decrypted subset of encryption keys, a corresponding subset of non-volatile storage regions is decrypted, thereby making the data in the non-volatile storage regions available to the authenticated user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a block diagram illustrating a computer system having one or more encrypted hard disk volumes;

FIG. 2 is a block diagram illustrating access to encrypted hard disk volumes by multiple users;

FIG. 3 is a flowchart illustrating the overall method for defining/creating different non-volatile storage regions, encrypting each using different encryption keys, and making available different subsets of the keys to different users;

FIG. 4 is a flowchart illustrating a method for defining/creating and encrypting multiple non-volatile storage regions using different encryption keys;

FIG. 5 is a flowchart illustrating a method for making available different subsets of the encryption keys to different users;

FIG. 6 is a flowchart illustrating a method for protecting the users' encryption keys using private-public key pairs;

FIG. 7 is a flowchart illustrating a method for authenticating a user attempting to log in to the computer system;

FIG. 8 is a flowchart illustrating a method for granting an authenticated user permission to decrypt and access a subset of the non-volatile storage regions; and

FIG. 9 illustrates an information handling system that is a simplified example of a computer system capable of performing the operations described herein.

### DETAILED DESCRIPTION

The following is intended to provide a detailed description of an example of the invention and should not be taken to be limiting of the invention itself. Rather, any number of variations may fall within the scope of the invention defined in the claims following the description.

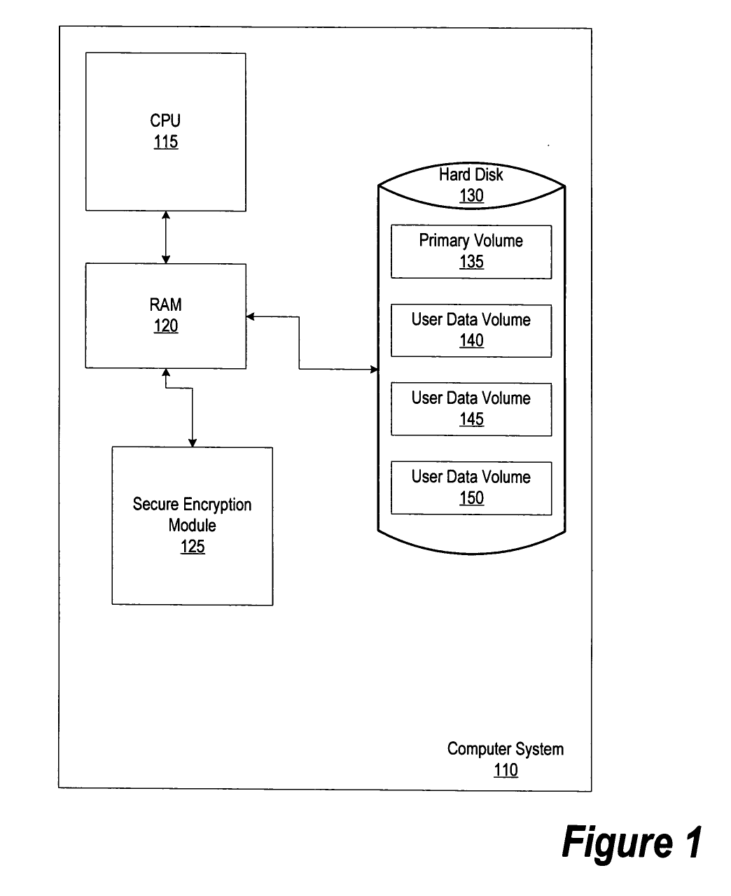

FIG. 1 is a block diagram illustrating a computer system having one or more encrypted volumes. Computer system 110 includes CPU 115 for controlling the operation of the computer system, RAM 120 for temporary storage during the operation of the computer system, hard disk 130 for more permanent data storage, and secure encryption module 125 for performing security and authentication related tasks.

In one embodiment, hard disk 130 is divided into a plurality of partitions giving rise to different volumes. The different volumes may also be created by using additional physical disks. In another embodiment, hard disk 130 may be divided into multiple directories/folders for the purpose of separating the data. In one embodiment, hard disk 130 is divided into primary volume 135 and one or more user data volumes such as user data volumes 140, 145, and 150. Primary volume 135 may hold, for example, the operating system and other data common to the users of the computer system. The user data volumes may each hold data specific to each of the users of the computer system.

In one embodiment, each of the volumes of hard disk 130 may be encrypted using different encryption keys. The encryption and decryption may be handled, for example, by full-disk encryption software. In one embodiment, the full-disk encryption software may be configured to load each time the computer system boots up. For example, the full-disk encryption software may be loaded by the BIOS of the computer system. The full-disk encryption software encrypts and decrypts each of the volumes using the encryption key corresponding to the volume.

Secure encryption module 125 is configured to handle security and authentication tasks for computer system 110 such as protecting sensitive data and authenticating users. Secure encryption module 125 may be configured, for example, to protect the volume encryption keys by generating private-public keys for each of the registered users of computer system 110. Secure Encryption Module 125 may then encrypt a user's volume encryption keys using the user's public key. The private key is securely stored within secure encryption module 125 and can be recovered only after user authentication. A user may be authenticated, for example, with a password or by other means such as a fingerprints scanner or a retina scanner.

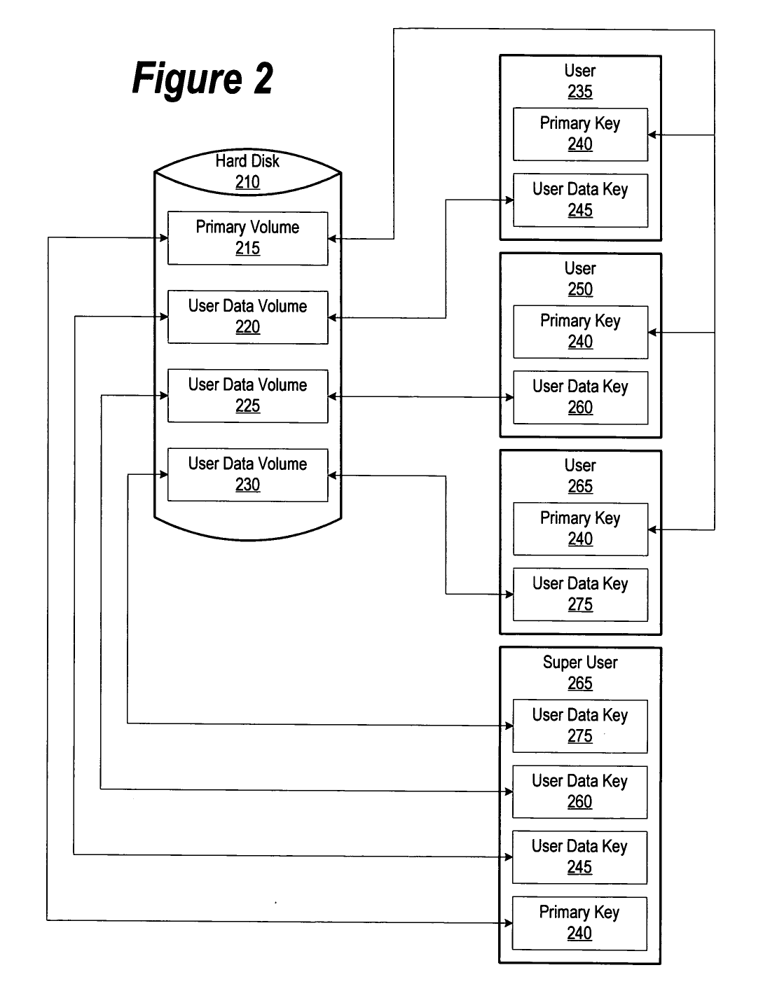

FIG. 2 is a block diagram illustrating access to encrypted volumes by multiple users. In one embodiment, different volumes may be created by dividing hard disk 210 into a plurality of partitions. The different volumes may also be created by using additional physical hard disks. In another embodiment, different storage regions may be created using multiple directories/folders.

In one embodiment, hard disk 130 is divided into primary volume 215 and one or more user data volumes such as user data volumes 220, 225, and 230. Each one of the partitions is encrypted using a different encryption key. A subset of the encryption keys is then made available to each of the registered users of the computer system according to the access privileges of each user.

A typical user may be given access to the primary key and to one of the user data keys, thereby being granted access to the primary volume and to a volume containing that user's user-specific data. For example, user 235 may be given access to primary key 240 and user data key 245 thereby being granted access to primary volume 215 and user data volume 220. User 250 may be given access to primary key 240 and user data key 260 thereby being granted access to primary volume 215 and user data volume 225. User 265 may be given access to primary key 240 and user data key 275 thereby being granted access to primary volume 215 and user data volume 230.

A user may be given access to any subset or all of the encryption keys. For example, an administrator such as super user 265 may be given access to all the encryption keys thereby being granted access to the primary volume as well as to all of the user data volumes.

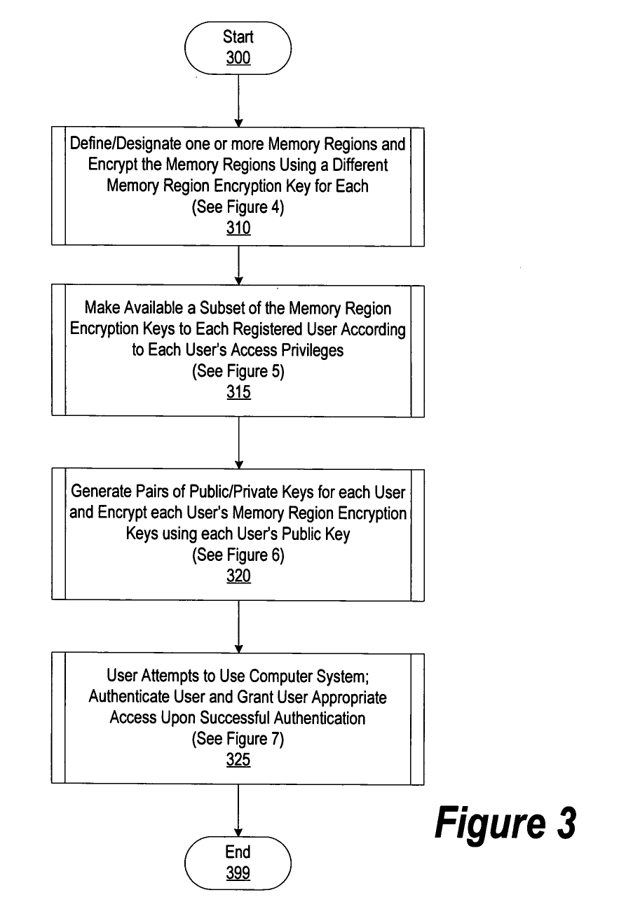

FIG. 3 is a flowchart illustrating the overall method for defining/creating different non-volatile storage regions, encrypting each using different encryption keys and making available different subsets of the keys to multiple users.

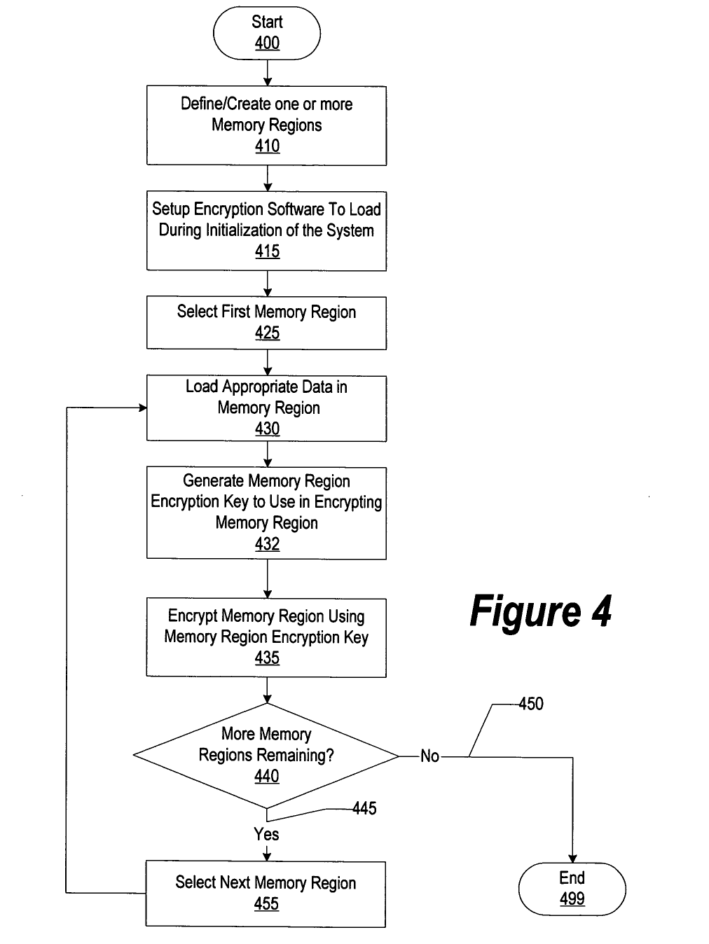

Processing begins at 300 whereupon, at step 310, one or more non-volatile storage regions are defined or designated. The non-volatile storage regions are then encrypted using a different non-volatile storage region encryption key for each of the non-volatile storage regions. More details on the processing that takes place at step 310 are provided in the flowchart of FIG. 4.

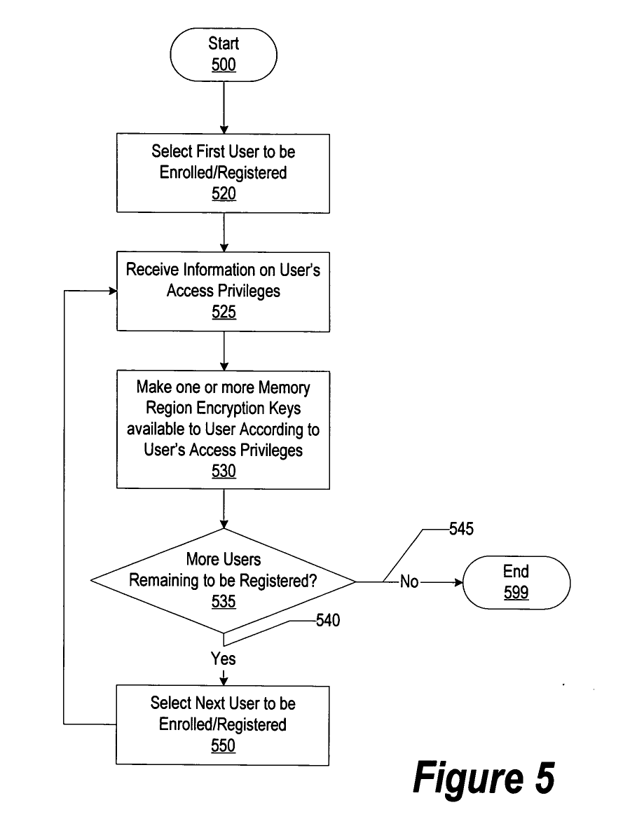

At step 315, a subset of the non-volatile storage region encryption keys is made available to each of the registered computer system users according to each user's access privileges. More details on the processing that takes place at step 315 are provided in the flowchart of FIG. 5.

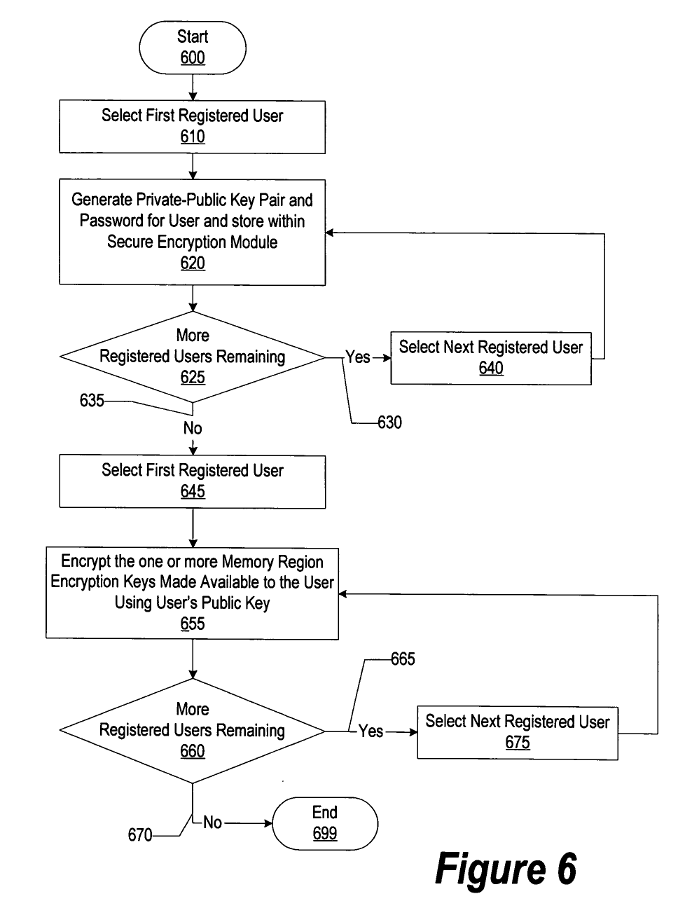

At step 320, pairs of private-public keys are generated for each of the registered users of the computer system. The key pairs are used to encrypt and protect the non-volatile storage region encryption keys to which each user has access. More details on the processing that takes place at step 320 are provided in the flowchart of FIG. 6.

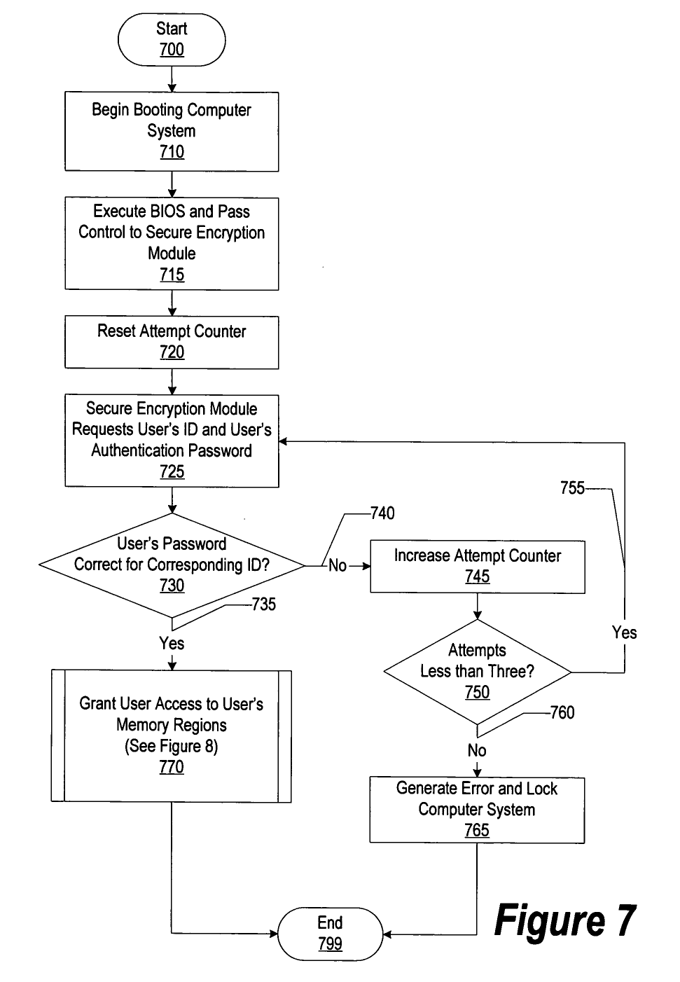

At step 325, a user attempts to use the computer system, and upon successful authorization, the user is granted appropriate access, which includes access to non-volatile storage region encryption keys and corresponding non-volatile storage regions. More details on the processing that takes place at step 325 are provided in the flowchart of FIG. 7.

FIG. 4 is a flowchart illustrating a method for defining/creating and encrypting multiple partitions on a disk using different encryption keys. Processing begins at 400 whereupon, at step 410, one or more non-volatile storage region partitions are defined or created. In one embodiment, the different non-volatile storage regions may be different partitions or different folders/directories on a hard disk. In another embodiment, the non-volatile storage regions may be volumes created by using multiple physical hard disks, for example.

At step 415, the encryption software is set up to load during initialization of the computer system. In one embodiment, the encryption software is configured to be loaded by the BIOS, and after proper user authentication transparently, the encryption software encrypts/decrypts the contents of the non-volatile storage regions.

At step 425, the first non-volatile storage region is selected, and at step 430, appropriate data is loaded in the non-volatile storage region. For example, the first non-volatile storage region may be the primary partition of a disk configured to store the operating system of the computer system and any other data common to all the users of the system. The other partitions may be configured to each store a user's user-specific data, for example.

At step 432, a non-volatile storage region encryption key is generated to be used in encrypting the contents of the selected non-volatile storage region. In one embodiment, the encryption software is configured to generate a symmetric non-volatile storage region encryption key and perform the encryption/decryption of the contents of the non-volatile storage region. The encryption software may use well-known encryption algorithms. In one embodiment, different types and sizes of encryption keys may be used to encrypt the different non-volatile storage regions. At step 435, the selected non-volatile storage region is encrypted using the generated non-volatile storage region encryption key. In one embodiment, only a subset of the non-volatile encryption regions may be encrypted; some of the regions may remain unencrypted.

A determination is then made as to whether more non-volatile storage regions are remaining requiring encryption, at decision 440. If there are no more non-volatile storage regions remaining, decision 440 branches to “no” branch 450 whereupon processing ends at 499. If there are more non-volatile storage regions remaining, decision 440 branches to “yes” branch 445 whereupon, at step 455, the next non-volatile storage region is selected. Processing then returns to step 430 where the setup of the next non-volatile storage region begins.

FIG. 5 is a flowchart illustrating a method for making available different subsets of the encryption keys to different users. Processing begins at 500 whereupon, at step 520, the first enrolled/registered user is selected, and at step 525, information is obtained about the selected user's access privileges. The information may contain, for example, a list of the non-volatile storage regions to which a user should be given access. A typical user, for example, may be given access to the main non-volatile storage region containing the operating system and other common data, and in addition, the user may be given access to the non-volatile storage region containing that user's user-specific data. Another user, in addition to the typical user's access, may be given access to a non-volatile storage region containing data for a group to which a user belongs. A super-user, such as a system administrator, may be given access to all the non-volatile storage regions.

At step 530, one or more non-volatile storage region encryption keys are made available to the user according to the user's access privileges. The user gains access to each key corresponding to each non-volatile storage region to which the user should be granted access.

A determination is then made as to whether more users are remaining to be enrolled/registered, at decision 535. If no more users are remaining, decision 535 branches to “no” branch 545 whereupon processing ends at 599.

If more users are remaining, decision 535 branches to “yes” branch 550 whereupon, at step 550, the next user to be enrolled/registered is selected. Processing then returns to step 525 where the next user is granted access to a subset of the non-volatile storage region encryption keys.

FIG. 6 is a flowchart illustrating a method for protecting the users' encryption keys using private-public key pairs. Processing begins at 600 whereupon, at step 610, the first registered user is selected, and at step 620, a private-public key pair is generated for the user. In one embodiment, the key pair may be generated using a secure encryption module. The secure encryption module may be configured to generate the key pair and then securely store the private key. In one embodiment, the secure encryption module may be configured to make available the private key after proper user authentication, which may be performed through a password or other means such as a retina scanner or a fingerprints scanner.

A determination is then made as to whether there are more registered users requiring private-public key pairs generated in decision 625. If there are more users requiring key pairs, decision 620 branches to “yes” branch 630 whereupon, at step 640, the next registered user is selected. Processing then returns to step 620 where the next user is set up.

If there are no more users remaining that require private-public key pairs, decision 625 branches to “no” branch 635 whereupon, at step 645, the first registered user is selected. At step 655, the selected user's non-volatile storage region encryption key or keys are encrypted using the user's public key, in one embodiment, within the secure encryption module. The non-volatile storage region encryption keys can only be decrypted by the secure encryption module (where the private key is kept) after a user is properly authenticated.

A determination is then made as to whether more registered users requiring non-volatile storage region encryption keys encrypted in decision 660. If there are more users requiring non-volatile storage region encryption keys encrypted, decision 660 branches to “yes” branch 655 whereupon, at step 675, the next registered user is selected. Processing then returns to step 655 where the next user is set up. If there are no more users requiring non-volatile storage region encryption keys encrypted, decision 660 branches to “no” branch 670 whereupon processing ends at 699.

FIG. 7 is a flowchart illustrating a method for authenticating a user attempting to log in to the computer system. Processing begins at 700 whereupon, at step 710, booting of the computer system begins, and at step 715, the BIOS first executes and then passes control to the secure encryption module. One of the functions of the secure encryption module is to authenticate a user attempting to use the computer, and upon successful authentication, decrypt for the user the non-volatile storage region encryption keys with which the user may then decrypt non-volatile storage regions of the computer system.

At step 720, the attempt counter is reset. The attempt character holds the number of times a user has attempted authentication in order to avoid dictionary-type attacks. At step 725, the secure encryption module requests the user for a user ID and a password to perform the authentication. In other embodiments, other authentication methods may be used such as fingerprints readers, retina scanners, etc.

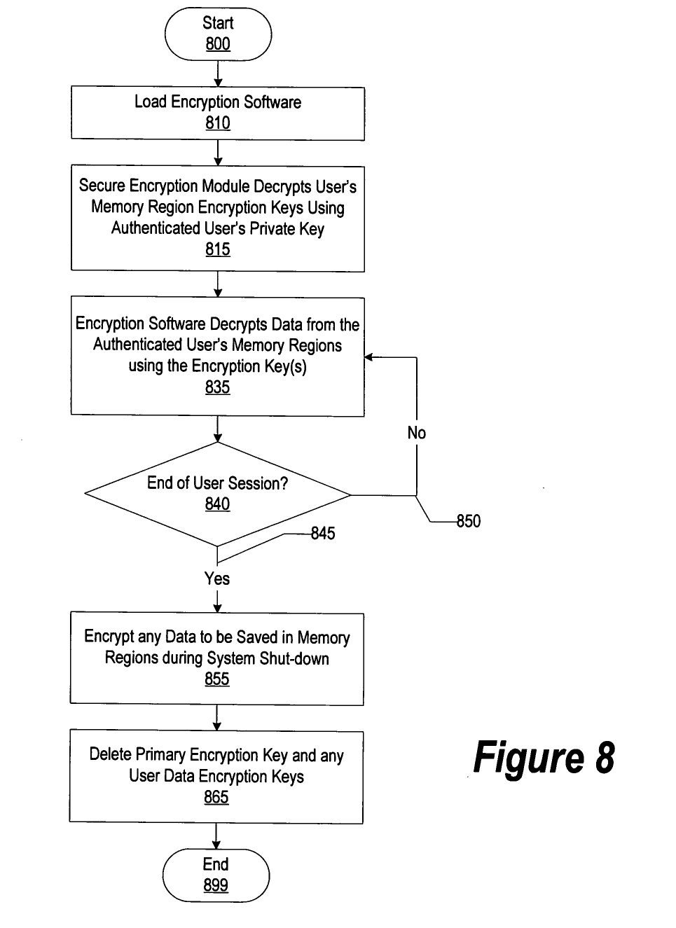

A determination is then made as to whether the user entered the correct user id and password at decision 730. If the user's user ID and password are correct, the user is authenticated, and decision 730 branches to “yes” branch 735 whereupon, at step 770, the user is granted access to the non-volatile storage regions corresponding to the user's non-volatile storage region encryption keys. More details on the processing that takes place at step 770 are provided in the flowchart of FIG. 8. Processing subsequently ends at 799.

If the user's user ID or password is incorrect, decision 730 branches to “no” branch 740 whereupon, at step 745, the attempt counter is increased by one. A determination is then made as to whether the user has attempted to enter a user ID and a password less than three times during this session at decision 750. If the number of attempts is still less than three, decision 750 branches to “yes” branch 755 whereupon processing returns to step 725 where the user is asked to reenter a user ID and a password.

If the user has made more than three unsuccessful attempts to be authenticated, decision 750 branches to “no” branch 760 whereupon, at step 765, the computer system is locked for a certain period and an error to that effect is issued to the user. Processing subsequently ends at 799.

FIG. 8 is a flowchart illustrating a method for granting an authenticated user permission to decrypt and access a subset of the non-volatile storage regions of the computer system. Processing begins at 800 whereupon, at step 810, the encryption software is loaded. The encryption software is configured to encrypt/decrypt non-volatile storage regions corresponding to a user's decrypted non-volatile storage region encryption keys. In one embodiment, the non-volatile storage regions may represent hard disk volumes, and the encryption software may be full-disk encryption software.

At step 815, in response to a user being authenticated, the secure encryption module decrypts the user's non-volatile storage region encryption keys using the user's private key. The user's private key is stored within the secure encryption module to prevent unauthorized access to the key.

Using the non-volatile storage region encryption keys provided by the secure encryption module, at step 835, the encryption software decrypts data from the non-volatile storage regions corresponding to the user's non-volatile storage region encryption keys upon the user's requesting data from these regions. At first, for example, the encryption software may decrypt the operating system so that the operating system can be loaded to run the computer system. The user also is granted permission to access data from other partitions, such as the partition containing the user's data.

A determination is then made as to whether the user has requested to end the session at decision 840. If the user has not requested to end the session, decision 840 branches to “no” branch 850 whereupon processing returns to step 835 where the encryption waits for more user data requests.

If the user has requested to end the session, decision 840 branches to “yes” branch 845 whereupon, at step 855, the encryption software encrypts data as data are saved back to the non-volatile storage regions during the shut-down process. At step 865, the encryption software deletes any non-volatile storage region encryption keys to prevent unauthorized access to the data in the non-volatile storage regions after the end of the authorized user session. A user must be re-authenticated in order to access data from the non-volatile storage regions. Processing ends at 899.

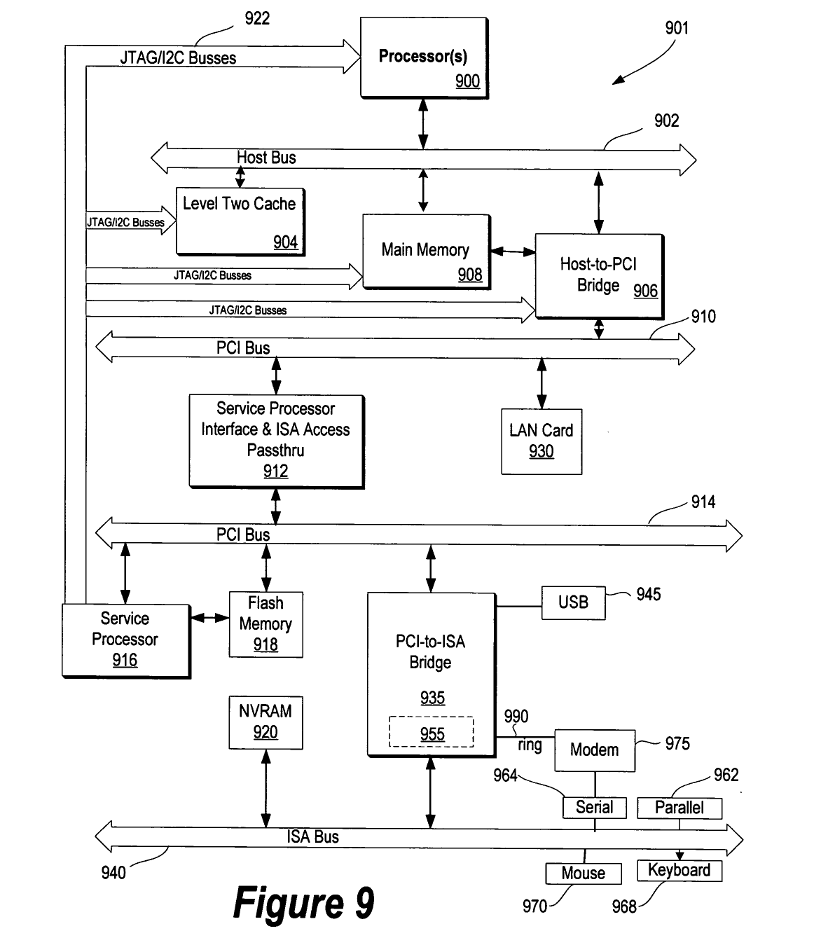

FIG. 9 illustrates information handling system 901 which is a simplified example of a computer system capable of performing the computing operations described herein. Computer system 901 includes processor 900 which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provide an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCI-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C busses 922 for communication with processor(s) 900 during initialization steps. JTAG/I2C busses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
encrypting a plurality of non-volatile storage regions, each being encrypted using a different encryption key from a set of encryption keys;
making a first subset of the encryption keys available to a first user thereby granting the first user access to a corresponding first subset of non-volatile storage regions, the first subset of the encryption keys consisting of one, a plurality, or all of the encryption keys; and
making a second subset of the encryption keys available to a second user thereby granting the second user access to a corresponding second subset of non-volatile storage regions, the second subset consisting of one, a plurality, or all of the encryption keys.

2. The method of claim 1, further comprising:
generating a first private-public encryption key pair and a second private-public encryption key pair;
making the first private key available only to the first user and the second private key only to the second user; and
encrypting the first subset of the encryption keys using the first public encryption key, and the second subset of the encryption keys using the second public encryption key.

3. The method of claim 2, further comprising:
storing the first private key and the second private key in a secure memory unit;
protecting access to the first private key with a first authentication token, the first authentication token being known only to the first user; and
protecting access to the second private key with a second authentication token, the second authentication token being known only to the second user.

4. The method of claim 3, further comprising:
requesting an authentication token from a user attempting to access one or more of the non-volatile storage regions;
authenticating the user, if the user's authentication token matches one of the authentication tokens used to protect access to one of the private keys;
decrypting, with the secure encryption module using the authenticated user's private key, a corresponding subset of encryption keys, in response to authenticating the user; and
decrypting a corresponding subset of non-volatile storage regions, thereby making the corresponding subset of non-volatile storage regions available to the authenticated user.

5. The method of claim 3, wherein the authentication tokens are selected from the group consisting of: passwords, fingerprints signatures, voice signatures, retina signatures, and secure access devices.

6. The method of claim 4, wherein the encrypting and decrypting the plurality of non-volatile storage regions are performed using full-disk encryption software.

7. The method of claim 1, wherein one of the non-volatile storage regions is adapted to store an operating system and data common to the first user and to the second user.

8. The method of claim 1, wherein one of the non-volatile storage regions is adapted to store user-specific data of the first user.

9. The method of claim 1, wherein one of the non-volatile storage regions is adapted to store user-specific data of the second user.

10. The method of claim 1, wherein the non-volatile storage regions are chosen from the group consisting of: volumes, disks, partitions, and folders/directories.

11. An apparatus comprising:
one or more processors;
a memory accessible by the one or more processors;
a plurality of non-volatile storage regions accessible by the one or more processors;
an encryption unit adapted to encrypt the plurality of non-volatile storage regions, each with a different encryption key selected from a set of encryption keys;
wherein a first subset of the encryption keys is made available to a first user thereby granting the first user access to a corresponding first subset of non-volatile storage regions, the first subset of the encryption keys consisting of one, a plurality, or all of the encryption keys; and
wherein a second subset of the encryption keys is made available to a second user thereby granting the second user access to a corresponding second subset of non-volatile storage regions, the second subset consisting of one, a plurality, or all of the encryption keys.

12. The apparatus of claim 11, further comprising a secure encryption module adapted to:
generate a first private-public encryption key pair and a second private-public encryption key pair;
make the first private key available only to the first user and the second private key only to the second user; and
encrypt the first subset of the encryption keys using the first public encryption key, and the second subset of the encryption keys using the second public encryption key.

13. The apparatus of claim 12, wherein the secure encryption module is further adapted to:
store the first private key and the second private key;
protect access to the first private key with a first authentication token, the first authentication token being known only to the first user; and
protect access to the second private key with a second authentication token, the second authentication token being known only to the second user.

14. The apparatus of claim 13,
wherein the secure encryption module is further adapted to:
request an authentication token from a user attempting to access one or more of the non-volatile storage regions,
authenticate the user, if the user's authentication token matches one of the authentication tokens used to protect access to one of the private keys, and
decrypt, using the authenticated user's private key, a corresponding subset of encryption keys, in response to authenticating the user, and
wherein the encryption unit is further adapted to decrypt a corresponding subset of non-volatile storage regions, thereby making the corresponding subset of non-volatile storage regions available to the authenticated user.

15. The apparatus of claim 13, wherein the authentication tokens are selected from the group consisting of: passwords, fingerprints signatures, voice signatures, retina signatures, and secure access devices.

16. The apparatus of claim 14, wherein the encryption unit comprises full-disk encryption software.

17. The apparatus of claim 11, wherein one of the non-volatile storage regions is adapted to store an operating system and data common to the first user and to the second user.

18. The apparatus of claim 11, wherein one of the non-volatile storage regions is adapted to store user-specific data of the first user.

19. The apparatus of claim 11, wherein one of the non-volatile storage regions is adapted to store user-specific data of the second user.

20. The apparatus of claim 11, wherein the non-volatile storage regions are chosen from the group consisting of: volumes, disks, partitions, and folders/directories.

21. A computer program product comprising:
means for encrypting a plurality of non-volatile storage regions, each non-volatile storage region being encrypted using a different encryption key from a set of encryption keys;
means for making a first subset of the encryption keys available to a first user thereby granting the first user access to a corresponding first subset of non-volatile storage regions, the first subset of the encryption keys consisting of one, a plurality, or all of the encryption keys; and
means for making a second subset of the encryption keys available to a second user thereby granting the second user access to a corresponding second subset of non-volatile storage regions, the second subset consisting of one, a plurality, or all of the encryption keys.

22. The computer program product of claim 21, further comprising:
means for generating a first private-public encryption key pair and a second private-public encryption key pair;
means for making the first private key available only to the first user and the second private key only to the second user; and
means for encrypting the first subset of the encryption keys using the first public encryption key and the second subset of the encryption keys using the second public encryption key.

23. The computer program product of claim 22, further comprising:
means for storing the first private key and the second private key;
means for protecting access to the first private key with a first authentication token, the first authentication token being known only to the first user; and
means for protecting access to the second private key with a second authentication token, the second authentication token being known only to the second user.

24. The computer program product of claim 23, further comprising:
means for requesting an authentication token from a user attempting to access one or more of the non-volatile storage regions;
means for authenticating the user, if the user's authentication token matches one of the authentication tokens used to protect access to one of the private keys;
means for decrypting, using the authenticated user's private key, a corresponding subset of encryption keys, in response to authenticating the user; and
means for decrypting a corresponding subset of non-volatile storage regions, thereby making the corresponding subset of non-volatile storage regions available to the authenticated user.

25. The computer program product of claim 23, wherein the authentication tokens are selected from the group consisting of: passwords, fingerprints signatures, voice signatures, retina signatures, and secure access devices.

26. The computer program product of claim 24, wherein the means for encrypting and the means for decrypting the plurality of non-volatile storage regions comprises full-disk encryption software.

27. The computer program product of claim 21, wherein one of the non-volatile storage regions is adapted to store an operating system and data common to the first user and the second user.

28. The computer program product of claim 21, wherein one of the non-volatile storage regions is adapted to store user-specific data of the first user.

29. The computer program product of claim 21, wherein one of the non-volatile storage regions is adapted to store user-specific data of the second user.

30. The computer program product of claim 21, wherein the non-volatile storage regions are chosen from the group consisting of: volumes, disks, partitions, and folders/directories.
